(19) United States
(12) Patent Application Publication
(10) Pub. No.: US 2006/0140591 A1
(43) Pub. Date: Jun. 29, 2006

(54) Systems and methods for load balancing audio/video streams

(75) Inventors: Leonardo W. Estevez, Rowlett, TX (US); Charles D. Lueck, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/023,841

(22) Filed: Dec. 28, 2004

(51) Int. Cl. H04N 7/06

(52) U.S. Cl. 386/105

(57) ABSTRACT

Embodiments of the present invention include systems and methods for load balancing audio/video streams to maximize the number of video frames that are actually rendered on a target device, thus giving the user of the target device a higher quality playback experience. Some embodiments are directed to transcoding an audio/video stream into a format that allows additional decoding time on a target device for more complex video sections of the stream. Additional decoding time is gained by duplicating lower complexity video frames in the video stream that precede the complex video sections and temporally expanding the audio stream by a small percentage around each of these load-balanced windows in the video stream. Other embodiments are directed to identifying the more complex video sections in real-time as the stream is being decoded on a target device, and temporally expanding the audio stream to allow more decoding time for these complex sections.

### BACKGROUND

Playing audiovisual content on mobile devices is becoming increasingly popular. Unfortunately, mobile devices are often limited in their ability to decode high resolution and high frame rate audio/video streams due to limitations in the processing power of mobile devices that are imposed by such design considerations as cost and power consumption. These limitations impact the quality of the viewing experience for the user of a mobile device because the video quality deteriorates if the decoder in the mobile device cannot decode frames in the video stream in the processing time available.

Various encoding and decoding techniques have been employed in an attempt to accommodate the limited processing bandwidth of mobile devices. Encoding techniques for video streams targeted to mobile devices generally attempt to reduce the bit rate in a video stream to be delivered on a mobile device. For example, an encoder may apply a simple frame-skipping algorithm to reduce the frame rate in a video stream, e.g., dropping four out of every five frames in a video clip to convert the video clip from a rate of thirty frames per second to a rate of six frames per second. However, these encoding techniques often have an adverse impact on the visual quality of the video stream when decoded and played on the mobile device.

One decoding technique used in mobile devices to achieve a more fluid playback of an encoded video stream involves decoding and pre-buffering several frames of data and applying algorithms for skipping frames if the decoder cannot keep up with the frame rate. However, as frame rates, resolution, motion, and image entropy increase in the video stream, these techniques cannot keep up and the visual quality suffers.

### SUMMARY

The problems noted above are solved in large part by systems and methods for load balancing audio/video streams to maximize the number of video frames that are actually rendered on a target device. In some embodiments, a first video frame of a video stream of an audio/video stream is received, a determination is made as to whether the first video frame can be decoded on a target device within a time available for decoding the first video frame, a second video frame in the video stream that occurs prior to the first video frame is duplicated and added to the video stream adjacent to the second video frame, and an audio stream associated with the video stream is temporally expanded by a length of time equivalent to the length of time added to the video stream by the addition of the duplicate frame.

Another embodiment provides a system for improving video quality on a target device comprising a transcoder. The transcoder trancodes an encoded audio/video stream to create a transcoded audio/video stream to be decoded at the target device. The transcoder is configured to determine a decode time for a video frame, and if the decode time exceeds a time available for decoding the video frame on the target device, to add a new predicted frame to the transcoded audio/video stream. This new predicted frame is a duplicate of a predicted frame preceding the video frame in the encoded audio/video stream. The transcoder also is configured to temporally expand a portion of an audio stream near an audio frame corresponding to the video frame such that the temporal expansion is equivalent to a frame rate for the target device.

In other embodiments, a video frame of a video stream is received, a determination is made that the video frame will not be decoded before the render time for the video frame, a previous video frame is rendered at the render time to obtain additional decode time, and the audio stream associated with the video stream is temporally expanded such that the amount of temporal expansion corresponds to the additional decode time.

In other embodiments, a system is provided comprising a display configured to display a decoded video stream of an encoded audio/video stream, speaker circuitry configured to play a decoded audio stream of the encoded audio/video stream, and a decoder subsystem configured to decode the encoded audio/video stream. The decoder subsystem is configured to determine that a video frame of the video stream is not decoded at a render time, to render a previous video frame of the video stream at the render time, and to temporally expand the audio stream to accommodate the rendering of the previous video frame.

In other embodiments, a system is provided comprising a video decoder, a video frame duplicator operatively connected to the video decoder, a video rendering component operatively connected to the video frame duplicator, an audio decoder, an audio dilator operatively connected to the audio decoder, an audio rendering component operatively connected to the audio dilator, and a synchronizer operatively connected to the audio rendering component, the audio dilator, the video frame duplicator, and the video rendering component. The synchronizer is configured to receive a signal from the audio rendering component to render a video frame, to determine that the video frame is not decoded, to signal the video frame duplicator to duplicate a previous video frame such that the duplicated previous video frame is rendered at a render time of the video frame, and to signal the audio dilator to temporally expand a portion of an audio stream corresponding to a video stream comprising the video frame.

In another embodiment, an encoded audio/visual stream to be decoded at a target device is transcoded and as part of the transcoding, a time required for decoding a video frame at the mobile device is estimated. If the estimated time exceeds an estimated time available on the target device for decoding the video frame, duplicate predicted frames are added to a video stream comprising the video frame before the video frame, and audio frames are added to an audio stream corresponding to the video stream wherein the time required to decode and render the added audio frames is equivalent to the time required to decode and render the duplicate predicted frames.

### BRIEF DESCRIPTION OF THE DRAWINGS

For a detailed description of illustrative embodiments of the invention, reference will now be made to the accompanying drawings in which like items are shown with the same reference numbers and:

FIGS. 1A-1C show a system for accessing audio/video streams from a mobile device in accordance with one or more embodiments of the invention;

FIG. 2 shows a block diagram of a system for transcoding an encoded audio/video stream in accordance with one or more embodiments of the invention;

FIGS. 3A-3C show an illustrative format of an encoded audio/video stream;

FIG. 4 shows an illustrative temporal expansion of an audio stream around a load-balanced window in an associated video stream in accordance with one or more embodiments of the invention;

FIG. 5 shows a flowgraph of a method for transcoding an encoded audio/video stream in accordance with one or more embodiments of the invention;

FIG. 6 shows a block diagram of a system for decoding an encoded audio/video stream in accordance with one or more embodiments of the invention; and

FIG. 7 shows a flowgraph of a method for decoding an encoded audio/video stream in accordance with one or more embodiments of the invention.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be illustrative of that embodiment, and not intended to suggest that the scope of the disclosure, including the claims, is limited to that embodiment.

For many audio/video streams, the prior art techniques for accommodating the limited processing bandwidth of mobile devices and other audio/video devices are not always necessary. Sometimes there are only a few areas in these streams that are of sufficient complexity to require more time to decode than the frame rate allows. Embodiments of the present invention include systems and methods for load balancing audio/video streams to maximize the number of video frames that are actually rendered on an audio/video device, thus giving the user of the audio/video device a higher quality playback experience. An audio/video device (also referred to herein as a target device) may be any device or system capable of playing an encoded audio/video stream including, for example, mobile devices, set-top boxes, digital video recorders, and general-purpose computer systems.

Some embodiments are directed to transcoding an audio/video stream into a format that allows additional decoding time on an audio/video device for more complex video sections of the stream, i.e., the video frames that the decoder in the audio/video device will not be able to decode within the time allowed before rendering. Additional decoding time may be gained by duplicating lower complexity video frames in the video stream that precede a more complex video frame and temporally expanding the audio stream by a small percentage (e.g., approximately 5-10%) around each of these load-balanced windows in the video stream. The amount of audio expansion corresponds in time to the time added by the duplicate lower-complexity video frames. The result of the transcoding is an audio/video stream with a slightly longer overall playing time and increased playback fluidity on an audio/video device. Multiple versions of transcoded audio/video streams corresponding to various types of audio/video devices can be created and made available on web sites similar to the way multiple versions of video media are made available for downloading based on channel limitations.

Other embodiments are directed to identifying the more complex video sections in real-time, i.e., as the stream is being decoded by an audio/video device, and temporally expanding the audio stream to allow more decoding time for these complex sections. In various real-time embodiments, the audio/video stream is not modified. Instead, when a frame cannot be decoded in time to be available before rendering, the previous frame is shown again and audio samples are duplicated to allow time to complete decoding the frame

The various embodiments of the invention are described herein using generic terminology for audio and video predictive coding concepts for convenience in illustrating the concepts. One of ordinary skill in the art will understand the implementation of these embodiments with respect to many audio and video predictive encoding schemes, i.e., encoding schemes in which frames of audio and video data are dependently coded based on previous frames. Such schemes include, but are not limited to, MPEG-x (Moving Picture Experts Group standards), H.26x (International Telecommunication Union Telecommunication Standardization Sector standards), AVI (Audio Video Interleaved), ASF (Advanced Streaming Format), and WMA/WMV (Windows Media Audio/Windows Media Video).

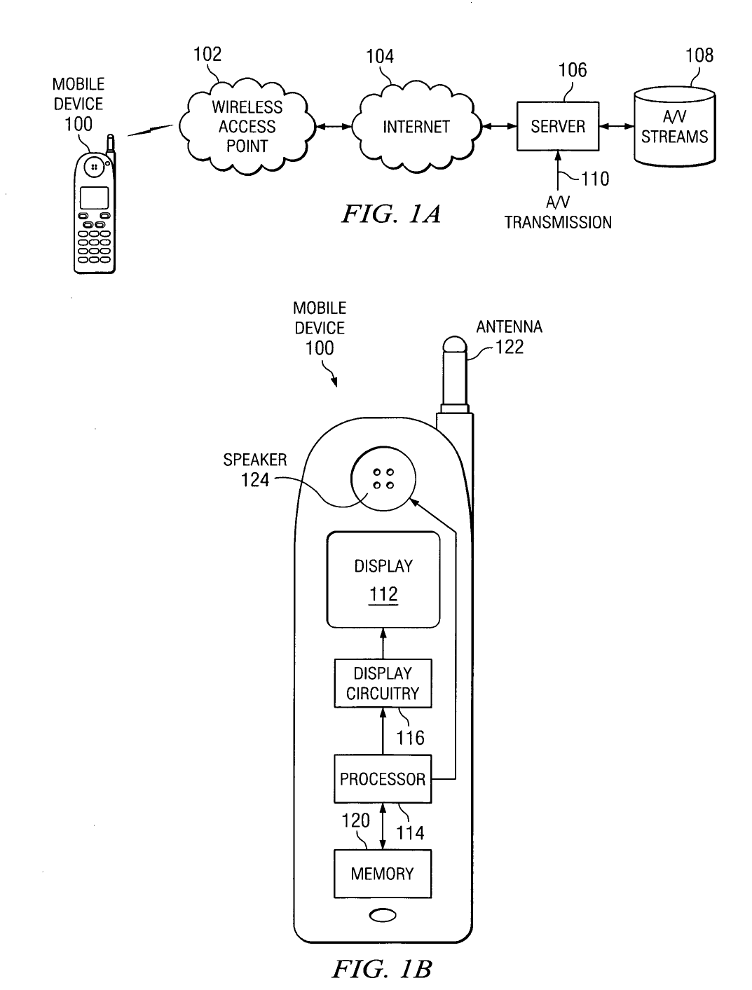

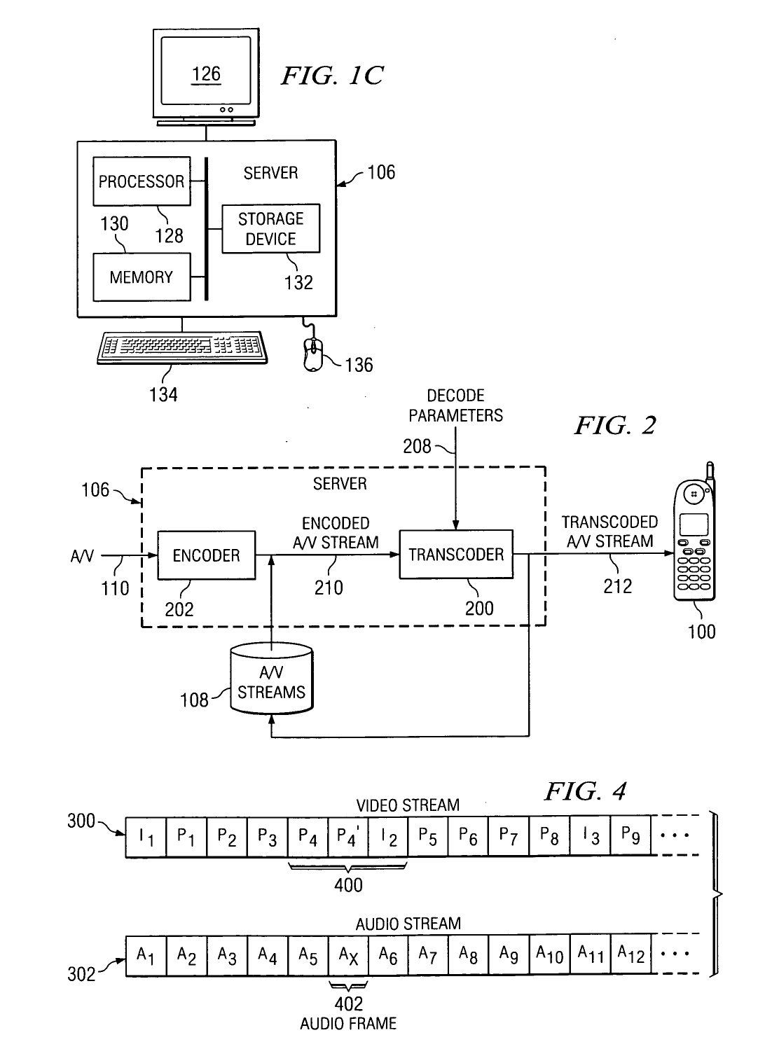

FIGS. 1A-1C show a system for accessing audio/video streams via a mobile device in accordance with one or more embodiments of the invention. As shown in FIG. 1A, the system includes a wireless mobile device 100, a wireless access point 102, the Internet 104, and a server 106. The mobile device 100 may be any portable device with a wireless interface that is configured to connect to a wireless access point 102 and to receive and play encoded audio/video streams. Such portable devices include, but are not limited to, a cellular telephone, a personal digital assistant (PDA), a web tablet, a pocket personal computer, a laptop computer, etc.

FIG. 1B shows an illustrative architecture for the mobile device 100. The mobile device 100 includes an antenna 122 for communicating with the wireless access point 102, a display 112, a speaker 124, and various components configured to decode and play audio/video streams. The components for decoding and playing audio/video streams include one or more of processor 114, memory 120, and display circuitry 116 for rendering decoded video frames on the display 112.

The wireless access point 102 may be part of a wireless network that transports information to and from devices capable of wireless communication, such as mobile device 100. The wireless network may include both wired and wireless components. For example, the wireless network may include a cellular tower that is linked to a wired telephone network. Typically, the cellular tower carries communication to and from cell phones, pagers, and other wireless devices, and the wired telephone network carries communication to regular phones, long-distance communication links, and the like.

The wireless access point 102 is coupled to the Internet 104 through a gateway (not specifically shown) that routes information between the wireless network and the Internet 104. For example, a user using the mobile device 100 may browse the Internet 104 by calling a certain number. When the wireless network receives the number, the wireless network is configured to pass information between the mobile device 100 and the gateway. The gateway may translate requests for web pages from the mobile device 100 to hypertext transfer protocol (HTTP) messages, which may then be sent to the Internet 104. The gateway may then translate responses to such messages into a form compatible with the mobile device 100. The gateway may also transform other messages sent from the mobile device 100 into information suitable for the Internet 104, such as e-mail, audio, video, voice communication, contact databases, calendars, appointments, etc.

A video server 106 is connected to the Internet 104. The video server provides a browser based interface for accessing encoded audio/video streams 108 or for accessing live audio/visual transmissions 110. The audio/video streams 108 are encoded using a predictive coding scheme that may be decoded and played by the mobile device 100. One of ordinary skill in the art will appreciate that the audio/video streams 108 may be, but are not required to be, stored in a storage device directly connected to the video server 106.

The video server 106 may be virtually any type of computer platform configured to operate as a server on the Internet 104. For example, as shown in FIG. 1C, the video server 106 includes a processor 128, associated memory 130, a storage device 132, and numerous other components typical of network servers (not shown). The video server 106 may also include an input device, such as a keyboard 134 and a mouse 136, and an output device, such as a monitor 126. The video server is connected to the Internet 104 via a network interface connection (not shown). Those skilled in the art will appreciate that these input and output means may take other forms. Further, those skilled in the art will appreciate that one or more elements of the video server 106 may be located at a remote location and connected to the other elements over a network.

In various embodiments, a user of the mobile device 100 may connect to the Internet 100 through the wireless access point 102, and select one of the audio/video streams 108 available through the video server 106. The selected video stream is downloaded to the mobile device 100 and either played for the user, or stored for later play. In one embodiment, the audio/video streams 108 are transcoded for playing on the mobile device 100 in accordance with methods and systems described herein. In another embodiment, the mobile device 100 is configured to play the audio/video streams 108 in accordance with methods and systems described herein.

In other embodiments, a user of the mobile device 100 may connect to the Internet 100 through the wireless access point 102, and select a link on the server 106 for receiving a live audio/video transmission 110. In one embodiment, the audio and video of the live transmission 110 are encoded in a predictive encoding format, transcoded for playing on the mobile device 100 in accordance with methods and systems described herein, and transmitted to the mobile device 100 where the transmission may be played immediately or stored for later play. In another embodiment, the live transmission 110 is encoded in a predictive encoding format and transmitted to the mobile device 100 which is configured to play the encoded audio and video of the live transmission 110 in accordance with methods and systems described herein.

FIG. 2 shows a block diagram of a system for transcoding an encoded audio/video stream in accordance with one or more embodiments of the invention. The mobile device transcoder 200, executing on the video server 106, is configured to receive an encoded audio/video stream 210 and decode parameters 208. The decode parameters 208 describe the decoding capabilities of the mobile device 100. These parameters may include, but are not limited to, the processing power available on the mobile device 100, the size of any decoding buffers, and the capabilities of any specialized decoding hardware. Using these decode parameters 208, the transcoder 200 modifies the audio and video of the stream 210 as described in more detail herein with reference to FIG. 4. Theses modifications result in a transcoded audio/video stream 212 that can be decoded on the mobile device 100 in a manner that permits better video quality than the original stream 210. The encoded audio/video stream 210 may either be a live audio/visual feed 110 that is encoded by an encoder 202 before receipt by the transcoder 200 or a precoded audio/visual stream selected from the stored audio/visual streams 108. The transcoded audio/video stream 212 may be transmitted to the mobile device 100 or stored for later access by the mobile device 100.

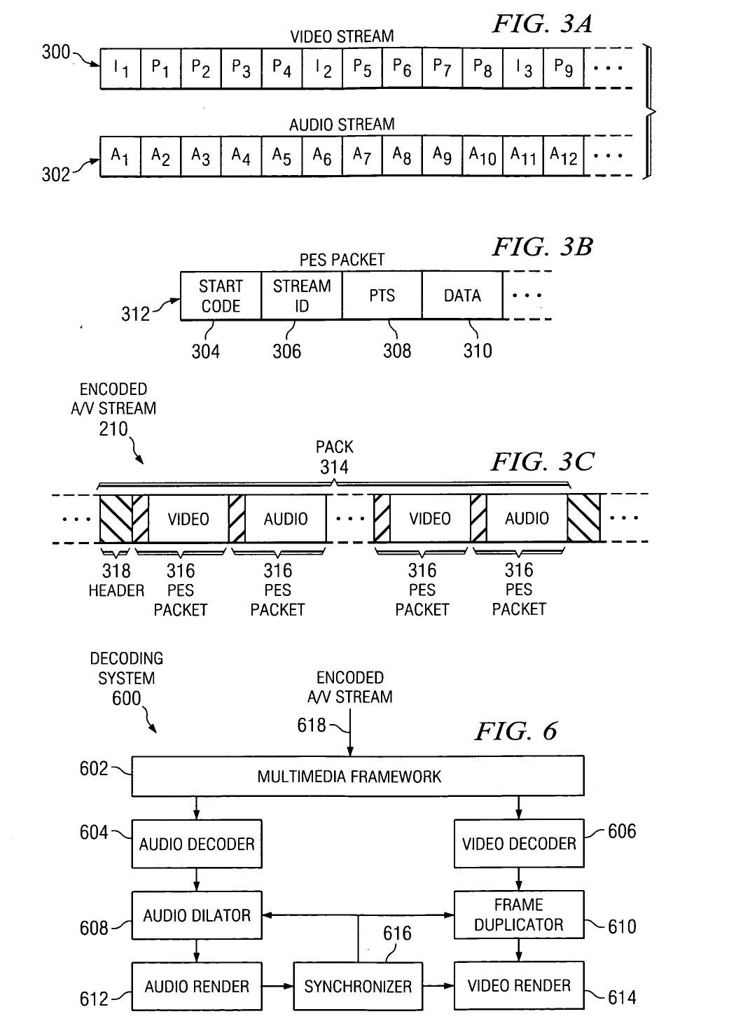

FIGS. 3A-3C show an illustrative format of the encoded audio/video stream 210. In essence, the audio/video stream 210 is an audio stream and a video stream with a common time base. To create the encoded audio/video stream 210, analog audio and video streams are respectively encoded by an audio and a video encoder, yielding an audio elementary stream and a video elementary stream. FIG. 3A illustrates the formats of these elementary streams. The audio elementary stream 302 is a bit stream of encoded audio frames and the video elementary stream 300 is a bit stream of encoded video frames in display order. There is a one-to-one correspondence between the audio frames and the video frames. The video elementary stream 300 includes both intracoded frames, represented by the notation Iₙ, and predicted frames, represented by the notation Pₙ. An intracoded video frame Iₙ is an encoded video frame that can be reconstructed without reference to any other video frame. A predicted frame Pₙ is an encoded video frame that can be reconstructed, i.e., forward predicted, with reference to the last intracoded frame and any intervening predicted frames. That is, a predicted frame Pₙ only includes changes relative to the frame immediately preceding it in the video elementary stream 300. In general, only small portions of a predicted frame Pₙ are different from the corresponding portions of its reference frame and only the differences are encoded.

Once encoded into frames, the elementary streams 300 and 302 are packetized into packets with a format as shown in FIG. 3B. A packetized elementary stream (PES) packet 312 includes a start code 304, a stream ID 306, an optional presentation time stamp (PTS) 308, and a date field 310. The start code 304 is a unique packet start code and the stream ID 306 identifies the type of the elementary stream, e.g., audio or video. The data field 310 holds a single frame of data. Each packet in the video PES contains either a single intracoded frame Iₙ or a single predicted frame Pₙ in the corresponding data field. Each packet in the audio PES contains a single audio frame in the corresponding data field.

The presentation time stamp 308 is an optional field containing a time stamp used for synchronizing a decoder of the audio/video stream to real time and for obtaining synch between the audio stream and the video stream. In some embodiments, a presentation time stamp is the value of a counter at the relative time the frame is encoded. The counter is driven by a 90 kHz clock is obtained by dividing down a master 27 MHz clock. The audio and video streams of the audio/video stream are locked to the same master 27 MHz clock and the presentation time stamps for corresponding audio and video frames must come from the same counter driven by that master clock. For example, when packetized, I₂ and A₆ will have the same counter value in their respective PTS fields. The PTS 308 is optional because, in practice, the time between rendering of frames is constant. As a result, a PTS 308 need not be included in every packet of a PES.

The audio PES and the video PES are multiplexed to create the encoded audio/video stream 210. FIG. 3C shows an illustrative format of the encoded audio/video stream 210 resulting from the multiplexing operation. During the multiplexing process, PES packets are assembled into packs. A pack 314 includes a header 318 and some number of audio and video PES packets 316. The header 318 contains a system clock reference (SCR) code that permits a decoder on the mobile device 100 to recreate the clock of the encoder used to create the encode audio/video stream 210. In some embodiments, the length of a pack 314 is not constrained except that a pack header must occur every at least every 0.7 seconds within the encoded audio/video stream 210.

Referring back to FIG. 2, depending on decoding resources available on the mobile device 100, such as processing power and buffer size, the mobile device 100 may not be able to decode portions of the encoded audio/video stream 210 in real-time. In an embodiment, the video decoder in the mobile device 100 has sufficient buffer space to decode one video frame ahead. That is, ideally, at any point in time, one video frame should in the process of being rendered, a second video frame is fully decoded and waiting in the buffer to be rendered, and a third video frame is being decoded. Each video frame in the encoded audio/video stream 210 may require a different decode time depending on the amount of data in the video frame and decoded video frames are rendered at a constant rate. As a result, the mobile device 100 may not be able to decode one or more frames in the video stream in time for synchronous display with the audio. If a video frame is not decoded when it is time to display that frame, the frame may be dropped. As a consequence, video quality would be degraded, and synchronization with the audio stream would be lost until a subsequent frame is successfully decoded and rendered. To help alleviate this potential problem, the transcoder 200 modifies the encoded audio/video stream 210 to create the transcoded audio/video stream 212 such that the decoder on the mobile device 100 will be able to properly decode a greater percentage of the video frames.

The transcoder 200 analyzes the encoded audio/video stream 210 to determine whether there are video frames in the video stream 300 (see FIG. 3A) of the encoded audio/video stream 210 that may not be decodable on the mobile device 100 before the rendering deadline for those video frames. In some embodiments, for each video frame, the transcoder 200 estimates the amount of time that will be required to decode that video frame on the mobile device 100 and the amount of time that will be available to decode that video frame, i.e., the decoder time period. These estimates are made based on the decoding parameters 208. The estimated frame decode time is compared to the estimated decoder time period to identify video frames that will not be decoded in the time available.

In some embodiments, the decoder time period for a video frame is partially determined by the frame rate of the target mobile device 100. For example, if the frame rate is 30 ms, then a decoder time period for a video frame may be at least 30 ms. However, if a video frame can be decoded in less than 30 ms, then the remaining time in that 30 ms period may be added to the 30 ms decode period of the subsequent video frame, thus allowing a longer decoder time period for that subsequent frame if needed.

For each video frame identified as not being decodable in the decoder time period, the transcoder 200 adds a duplicate predicted frame to the video stream to create a load-balanced window to allow more decode time for the problematic frame. The duplicate predicted frame is a copy of the predicted frame immediately preceding the problematic frame in the video stream 300 and is inserted in the video stream 300 immediately adjacent to the predicted frame it replicates, thus creating a load-balanced window of video. Because the predicted frame is a duplicate of the preceding frame and is expressed in predictive format, it requires a minimal amount of data and a minimal decoding time. The surplus decoding time will be added to the decoder time period for the problematic frame.

In order to maintain synchronicity between the audio stream 302 and the video stream 300, the transcoder 200 also expands the audio stream 302 temporally by the same amount of time that has been added to the video stream 300 by the addition of the duplicate predicted frame. That is, the transcoder 200 will expand the audio stream 302 using a technique that will add the equivalent of one audio frame to audio stream 302 for every duplicate predicted frame added to the video stream 300. In addition, the temporal expansion of the audio stream is accomplished such that a listener will not perceive that the audio has been expanded.

In some embodiments, the temporal expansion of the audio stream 302 may be accomplished by dilating a window of audio around a load-balanced window in the video stream 300. The window of audio to be temporally expanded is selected such that it spans the load-balanced window. The size of this window of audio is selected such that the overall dilation required to expand the audio stream in that window by the amount of time needed is no more than approximately 10%. In some embodiments, the audio stream is decoded, dilated in the selected areas, and then re-encoded to create a transcoded audio stream having the same number of audio frames as there are video frames in the transcoded video stream.

One of ordinary skill in the art will appreciate processes that may be used to dilate the audio within the selected window. Either time-domain or frequency-domain expansion techniques may be used to accomplish the requisite temporal expansion. Examples of applicable time-domain techniques include synchronized overlap-and-add, pitch-synchronous overlap-and-add (PSOLA), or time-domain harmonic scaling. Phase vocoding is one commonly used frequency-domain expansion technique.

FIG. 4 shows an illustrative temporal expansion of an audio stream around a load-balanced window in a video stream in accordance with one or more embodiments of the invention. The original audio stream 302 and video stream 300 are shown in FIG. 3A. During the transcoding process, the intracoded video frame I₂ is determined to have a complexity that would require more time to decode than would be available during playback. Therefore, the predicted frame P₄ is duplicated and inserted into the video stream 300 immediately preceding the intracoded video frame I₂, creating a load-balanced window of video 400. The duplicated predicted frame is designated P₄′. The associated audio stream 302 is then expanded temporally to add another frame of audio data 402 in a window of audio around the load-balanced window 400.

One of ordinary skill in the art will appreciate that other techniques for temporally expanding the audio stream may also be used. For example, the audio stream can be analyzed to identify an expansion area such as silent gap or a long homogeneous frequency window that is sufficiently near a load-balanced window of video that a small expansion in that area would create little or no perception of loss of “lip-synch.” In such expansion areas, an audio frame may be replicated with no impact on the perceived quality of the audio.

Referring back to FIGS. 2 and 3A, in some embodiments, after the temporal expansions are performed on the video stream 300 and the audio stream 302, the transcoded elementary streams are packetized and multiplexed to create the transcoded audio/video stream 212.

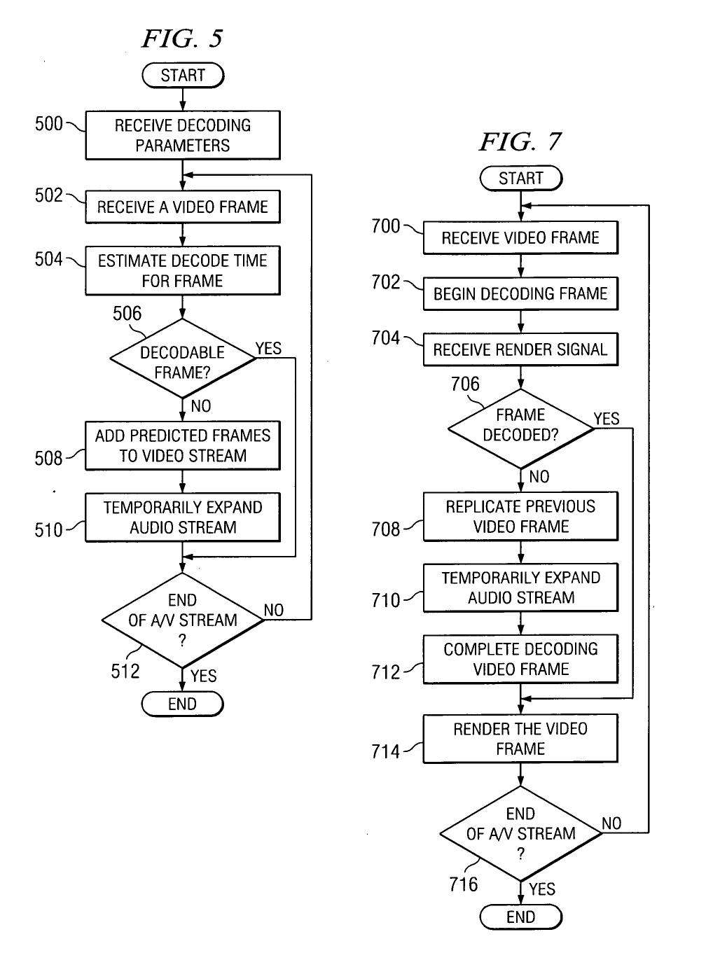

FIG. 5 shows a flowgraph of a method for transcoding an encoded audio/video stream in accordance with one or more embodiments of the invention. Initially, the decoding parameters of a target audio/video device are received (500). These decoding parameters describe the decoding capabilities of the target device. Then, a video frame of the audio/video stream to be transcoded is received (502). The amount of time required to decode the video frame on the target device is estimated using the decoding parameters (504). Using this estimated decode time, a determination is made (506) as to whether the video frame can be decoded within an estimated amount of time the decoder of the target device will have to decode the video frame, i.e., the decoder time period. If the frame is decodable within the decoder time period, then the transcoding process receives the next video frame (502), if any (512).

If the frame is not decodable within the decoder time period, then one or more predicted frames are added to the video stream of the encoded audio/video stream to increase the decode time period (508). The number of added predicted frames is determined by the amount of additional time needed to decode the undecodable frame. Each added predicted frame is a duplicate of a predicted frame preceding the undecodable frame in the video stream and is inserted in the video stream immediately adjacent to the predicted frame it replicates. The audio stream of the encoded audio/video stream is also temporally expanded for an amount of time equivalent to the time added to the video stream by the addition of the one or more duplicate predicted frames (510). The transcoding process then receives the next video frame (502), if any (512). The transcoding process continues until all video frames in the audio/visual stream have been received (512).

FIG. 6 shows a block diagram of a system for decoding an encoded audio/video stream in accordance with one or more embodiments of the invention. In some embodiments, the decoding system 600 may be implemented in a wireless mobile device 100 (see FIGS. 1A and 1B) that plays audio and video at a constant frame rate. One of ordinary skill in the art will appreciate that the components of the decoding system 600 may be implemented as software instructions stored in the memory 120 of the wireless mobile device 100 and/or as specialized circuitry.

The decoding system 600 may include a multimedia framework 602, components for decoding and rendering an audio bit stream (604, 608, and 612), components for decoding and rendering a video bit stream associated with the audio bit stream (606, 610, and 614), and a synchronization component 616 for managing the synchronous playing of the frames of the audio stream and the video stream. The multimedia framework 602 is configured to receive an encoded audio/video stream 618. An illustrative format of the encoded audio/video stream 618 is discussed above in reference to FIGS. 3A-3C. The multimedia framework 602 is further configured to demultiplex the encoded audio/video stream 618 to separate the audio frames from the video frames, and to send the audio frames to the audio decoder 604 and the video frames to the video decoder 606.

The audio decoder 604 is configured to decode the received audio frames and store the decoded frames in an audio buffer (not specifically shown). The audio dilator 608 is configured to dilate audio in the audio buffer if the audio stream needs to be temporally expanded to allow more time for decoding a video frame. The audio render component 612 is configured to render audio frames in the audio buffer and to signal the synchronizer 610 that it is time to render a video frame.

The video decoder 606 is configured to decode the received video frames and store the decoded frames in a video buffer (not specifically shown. The frame duplicator 610 is configured to duplicate the last frame rendered if such duplication is needed to allow more time for the video decoder 606 to decode the next video frame in the video stream. The video render component 614 is configured to render decoded video frames in the video buffer when signaled by the synchronizer 616 to do so.

The synchronizer 616 is configured to receive signals from the audio render component 612 when it is time to render a new video frame and to signal the video render component 614 to render a video frame. The synchronizer 616 is also configured to determine if a video frame had been fully decoded and is ready to be rendered. In addition, the synchronizer 616 is configured to communicate with the frame duplicator 610 and the audio dilator 608 in the event that the video frame that corresponds to the audio frame to be rendered by the audio render component 612 is not ready to be rendered at the appropriate time, i.e., the video frame is still being decoded when the audio render component 612 signals the synchronizer to display that video frame.

In some embodiments, when the synchronizer 616 receives a signal from the audio render component 612 to display the video frame corresponding to the audio frame to be rendered, the synchronizer 616 determines whether or not that video frame is fully decoded. If the video frame is decoded and available in the video buffer, the synchronizer 616 signals the video render component 614 to render that video frame. If the video frame is not yet fully decoded, the synchronizer 616 signals the frame duplicator 610 to duplicate the previous frame, i.e., the video frame that was displayed immediately prior to one still being decoded, thus allowing more time for the video decoder 606 to complete decoding the next frame. The synchronizer 616 will also signal the audio dilator 608 to temporally expand the audio stream by the same amount of time that has been added to the video rendering process by duplicating the video frame. For example, In some embodiments, if the frame rate for presenting the encoded audio/visual stream 618 on the mobile device 100 is 30 ms, then for each video frame duplicated, the audio dilator 608 will expand the audio stream by 30 ms. The temporal expansion of the audio stream is accomplished in such a way that the change to the audio is not perceived by the listener and “lip synch” is not lost or is only minimally affected. In some embodiments, the temporal expansion of the audio stream is accomplished by duplicating audio samples from the audio decoder 604 before rendering. The time period over which the audio dilation occurs is selected such that the overall dilation of the audio is approximately 10% or less.

While the embodiment of FIG. 6 has been shown and described with the audio stream serving as the master for synchronization purposes, one of ordinary skill in the art will appreciate other embodiments in which the video stream may control synchronization during playback.

FIG. 7 shows a flowgraph of a method for decoding an encoded audio/video stream in accordance with one or more embodiments of the invention. Initially, an encoded video frame received (700) and decoding of that video frame is started (702). When a render signal for the video is received (704), a check is made to determine if the video frame is fully decoded and ready to be rendered (706). If the video frame is fully decoded, it is rendered (714), and processing continues with another video frame (700), if any (716).

If the video frame is not yet fully decoded, then the video frame that was displayed during the last rendering period is replicated (708) and the audio stream is temporally expanded by a length of time equivalent to the frame rate for displaying video frames (710). The decoding of the video frame is completed (712) and the video frame is rendered (714). Processing continues with another video frame (700), if any (716).

The embodiments of the invention described herein present systems and methods for effectively load balancing an audio/video stream for a audio/video device so that areas of the video which require more processing bandwidth are given additional time to be processed and rendered. This load balancing can be accomplished by transcoding the audio/video stream prior to transmission to the audio/video device or in real-time during playback of the stream on the audio/video device. The effect of this tuning is that more video frames are rendered, thus increasing the perceived fluidity and performance of the playback of the audio/video stream.

While embodiments of the systems and methods of the present invention have been described herein in reference to an illustrative format of an encoded audio/video stream, one of ordinary skill in the art will appreciate that other formats may be used in embodiments of the invention. For example, the sizes of the individual video frames in a video stream may vary from frame to frame. Similarly, the sizes of the individual audio frames in an audio stream may vary. In some embodiments, the audio frames and video frames are not of equivalent size. In addition, there need not be a one-to-one correspondence between audio frames and video frames in all embodiments. In some embodiments, the number of audio frames may be significantly larger than the number of video frames. Furthermore, in various embodiments, the frame rate of the audio stream may differ from the frame rate of the video stream.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method for transcoding an encoded audio/video stream comprising:
receiving a first video frame of a video stream of the encoded audio/video stream;
determining whether the first video frame can be decoded on a target device within a time available for decoding the first video frame;
duplicating a second video frame in the video stream that occurs prior to the first video frame;
adding the duplicate video frame to the video stream adjacent to the second video frame; and
temporally expanding an audio stream associated with the video stream by a length of time equivalent to a length of time added to the video stream by the addition of the duplicate video frame.

2. The method of claim 1, further comprising encoding the duplicate video frame as a predicted frame that only contains changes relative to a video frame preceding the predicted frame.

3. The method of claim 1, wherein the second video frame is a predicted frame.

4. The method of claim 1, wherein the second video frame immediately precedes the first video frame in the video stream.

5. The method of claim 1, wherein determining whether the first video frame can be decoded further comprises determining that a decode time period for the first video frame is longer than a decoder time period.

6. The method of claim 5, wherein determining further comprises:
estimating the decode time period of the target device for the first video frame; and
determining an available decoder time period for the target device.

7. The method of claim 1, further comprising:
receiving decoding capabilities of the target device; and
wherein determining whether the video frame can be decoded further comprises using the decoding capabilities.

8. The method of claim 1, wherein expanding an audio stream further comprises dilating a portion of the audio stream.

9. The method of claim 8, wherein the dilation is no more than approximately ten percent.

10. The method of claim 1, wherein expanding an audio stream further comprises adding an audio frame in a silent gap in the audio stream.

11. The method of claim 1, wherein the target device is a mobile device.

12. A system for improving video playback quality, the system comprising:
a transcoder that transcodes an encoded audio/video stream to create a transcoded audio/video stream to be decoded at a target device, wherein the transcoder is configured to determine a decode time for a video frame, and if the decode time exceeds a time available for decoding the video frame on the target device, to add a new predicted frame to a video stream comprising the video frame, wherein the new predicted frame is a duplicate of a predicted frame occurring before the video frame, and to temporally expand an audio stream corresponding to the video stream, wherein the temporal expansion is equivalent to a frame rate of the target device.

13. The system of claim 12, wherein the transcoder is further configured to receive a decoding parameter for the target device, and to use the decoding parameter to determine the decode time.

14. The system of claim 12, wherein the transcoder is further configured to temporally expand the audio stream by dilating a portion of the audio stream.

15. The system of claim 14, wherein the dilation is no more than approximately ten percent.

16. The system of claim 12, further comprising:
a storage device accessible by the transcoder wherein the encoded audio/video stream is stored on the storage device.

17. The system of claim 16, wherein the transcoder is configured to store the transcoded audio/video stream on the storage device.

18. The system of claim 12, wherein the transcoder is further configured to transmit the transcoded audio/video stream to the target device.

19. The system of claim 12, further comprising an encoder operatively connected to the transcoder, wherein the encoder is configured to receive a live audio/video transmission and to create the encoded audio/video stream from the live audio/video transmission.

20. The system of claim 12, wherein the target device is a mobile device.

21. A method for decoding an audio/video stream comprising:
receiving a video frame of a video stream;
determining that the video frame will not be decoded before a render time for the video frame;
rendering a previous video frame at the render time to obtain additional decode time; and
expanding an audio stream associated with the video stream temporally wherein an amount of temporal expansion corresponds to the additional decode time.

22. The method of claim 21, wherein expanding an audio stream further comprises replicating audio samples in the audio stream in such a manner that a human ear does not perceive a change in audio quality of the audio stream.

23. The method of claim 21, wherein the video frame is received on a mobile device.

24. A system comprising:
a display configured to display a decoded video stream of an encoded audio/video stream;
speaker circuitry configured to play a decoded audio stream of the encoded audio/video stream; and
a decoder subsystem configured to decode the audio/video stream, wherein the decoder subsystem is configured to:
determine that a video frame of the video stream is not decoded at a render time;
render a previous video frame of the video stream at the render time; and
temporally expand the audio stream to accommodate the rendering of the previous video frame.

25. The system of claim 24, wherein the decoder subsystem further comprises:
a video frame replication component configured to replicate the previous video frame;
an audio dilation component configured to temporally expand the audio; and
a synchronizer connected to the video frame replication component and the audio dilation component to determine that the video frame is not decoded at the render time.

26. A system comprising:
a video decoder;
a video frame duplicator operatively connected to the video decoder;
a video rendering component operatively connected to the video frame duplicator;
an audio decoder;
an audio dilator operatively connected to the audio decoder;
an audio rendering component operatively connected to the audio dilator; and
a synchronizer operatively connected to the audio rendering component, the audio dilator, the video frame duplicator, and the video rendering component,
wherein the synchronizer is configured to
receive a signal from the audio rendering component to render a video frame;
determine that the video frame is not decoded;
signal the video frame duplicator to duplicate a previous video frame, wherein the duplicated previous video frame is rendered at a render time of the video frame; and
signal the audio dilator to temporally expand a portion of an audio stream corresponding to a video stream comprising the video frame.

27. A method, comprising:
transcoding an encoded audio/visual stream to be decoded at a target device;
estimating, as part of the transcoding, a time required for decoding a video frame at the target device; and
if the estimated time exceeds an estimated time available on the target device for decoding the video frame,
adding duplicate predicted frames to a video stream comprising the video frame before the video frame; and
adding audio frames to an audio stream corresponding to the video stream, wherein the time required to decode and render the added audio frames is equivalent to the time required to decode and render the duplicate predicted frames.
